(19) United States
(12) Patent Application Publication
(10) Pub. No.: US 2010/0237118 A1
(43) Pub. Date: Sep. 23, 2010

(54) BICYCLE HYDRATION BOTTLE SYSTEM

(76) Inventor: Edward Lafe Altshuler, Erie, CO (US)

Correspondence Address: Edward Altshuler, 4678 Edie Place, Erie, CO, 80516, US

(21) Appl. No.: 12/728,239

(22) Filed: Mar. 21, 2010

Related U.S. Application Data
(60) Provisional application No. 61/162,315, filed on Mar. 22, 2009.

(51) Int. Cl. B62J 11/00

(52) U.S. Cl. 224/414

(57) ABSTRACT

A bottle holder for a bicycle including a frame attachable to a seat post assembly is described herein. The seat post assembly possesses a seat post extending at least partially in a vertical direction from the bicycle along a seat post axis such that the seat post axis extending concentrically along the length of the seat post. A first cage and a second cage are attached to the frame wherein each of the cages is adapted to retain a bottle. Each bottle possesses a top end and a bottom end wherein, when retained in either of the cages, the top end of the bottles are above the bottom end of the bottles, respectively, and the top ends of the bottles are closer to the seat post axis than the bottom end of the bottles such that a bottle axis that extends substantially centrically through the top and bottom ends of each bottle is at an angle of least seven degrees relative to the vertical direction.

### CROSS-REFERENCE TO RELATED APPLICATIONS

This application claims priority to and the benefit of U.S. Provisional Patent Application No. 61/162,315 entitled: Bicycle hydration bottle system, filed on Mar. 22, 2009, the entire disclosure of which is hereby incorporated by reference.

### BACKGROUND OF THE INVENTION

1. Field of the Invention

The present invention relates generally to positioning water bottles for accessibility on a bicycle.

2. Description of Related Art

Most bicycles are equipped with two water bottle holders that are located at the inner triangle of a bicycle frame 100 as shown in FIG. 1. Additional water bottles can be placed on a bicycle by way of non-standard bottle holder components in positions along the inside of the triangle. Typical non-standard bottle holder components include handle bar hydration devices and seat post assembly devices. Handle bar hydration devices are generally used for competition purposes because they are streamlined and do not require a bicycle rider to move out of a racing position to access water. Seat post assembly devices are typically used for extended bicycle tours because they are not streamlined and require a bicycle rider to get out of racing position to access water bottles disposed in the seat post assembly devices, however the water bottles are easily refilled. As shown, typical seat post assembly devices are angled between 100 degrees and 120 degrees from the horizontal (the horizontal coordinates 325 are shown in FIG. 3B). Though, this angle makes it easy to load water bottles in the cages associated with the seat post assembly device, water bottles may be subject to being ejected from the water bottle holder in the event the bicycle goes over a bump, like a rail-road track, for example.

In an effort to improve managing race position and racer friendly geometry, both methods and apparatuses directed to a novel bottle holder are disclosed herein. It is to innovations related to this subject matter that the claimed invention is generally directed.

### SUMMARY OF THE INVENTION

The present invention generally relates to positioning water bottles for accessibility on a bicycle and overcomes the disadvantages and limitations of the prior art by positioning the bottles at an angle that is more optimally accessible to a bicycle rider.

Therefore, aspects of the present invention can include: a bottle holder for a bicycle comprising: a frame attachable to a seat post assembly, the seat post assembly having a seat post extending at least partially in a vertical direction from the bicycle along a seat post axis, the seat post axis extending concentrically along the length of the seat post; a first cage and a second cage attached to the frame wherein each of the cages are adapted to retain a bottle, the bottle possessing a top end and a bottom end wherein, when retained in either of the cages, the top end of the bottle is above the bottom end of the bottle and the top end of the bottle is closer to the seat post axis than the bottom end of the bottle such that a bottle axis that extends substantially centrically through the top and bottom ends is at an angle of least seven degrees relative to the vertical direction. The frame can solely attached to the seat post assembly. The angle can be less than eighty degrees. Either of the cages can receive the bottle via a receiving end associated with the cages wherein the bottle slidably engages the cages from the bottom end of the bottle first. The seat assembly can further comprise a bicycle seat and wherein the frame is at least partially attached therewith. The frame can extend away from the back of the bicycle seat. Each of the cages provides a means for retaining the bottle at the angle. The bottle holder can further comprise a utility space between the first cage and the second cage. The utility space can be capable of accommodating a utility bag. The first cage and the second cage can be adapted to be moved apart to alter the utility space. The first cage can possess a first receiving end and a first base end and the second cage possesses a second receiving end and a second base end, the receiving ends are further apart than the base ends. The first cage and the second cage can be arranged coplanar. The angle can be adjustable.

In another aspect of the present invention, method for using a dual bottle holder can comprise steps for: providing a seat post assembly that cooperates with a bicycle, the seat post assembly having a seat post extending at least partially in a vertical direction from the bicycle and having a seat post axis extends concentrically along the length of the seat post; providing a frame attached to the seat post assembly, a first cage and a second cage attached to the frame wherein the first cage possesses a first receiving end and the second cage possesses a second receiving end; inserting a first bottle in the first receiving end, the bottle having a top end and a bottom end; and retaining the first bottle in the first bottle cage in a position wherein the top end is above the bottom end and the top end is closer to the seat post axis than the bottom end and wherein a bottle axis associated with the first bottle that extends substantially centrically through the top and bottom ends is at an angle of least seven degrees relative to the vertical direction. The method can further comprise the steps for: inserting a second bottle, that is similar in construction to the first bottle, in the second receiving end; and retaining the second bottle in the second bottle cage at the angle. The method can further comprise the step for attaching a utility bag in an accommodating space between the first bottle cage and the second bottle cage.

In yet another aspect of the present invention, a bottle holder for a bicycle can comprise a means for attaching a frame to a seat post assembly, the seat post assembly having a seat post extending at least partially in a vertical direction from the bicycle wherein the seat post possesses a seat post axis that extends concentrically along the length of the seat post; a first cage and a second cage attached to the frame wherein each of the cages provides a means for retaining a bottle at an angle of at least seven degrees wherein the at least seven degrees is established by a bottle axis that extends substantially centrically through a top end of the bottle and bottom end of the bottle relative to the vertical direction, the top end of the bottle is above the bottom end of the bottle and the top end of the bottle is closer to the seat post axis than the bottom end of the bottle. The bottle holder can further comprise a means for attaching a utility bag to the bottle holder in an accommodating utility space. The bottle holder can further comprise a means for adjusting the utility space. The angle can be constrained.

### BRIEF DESCRIPTION OF THE DRAWINGS

FIG. 1 is a prior art pictorial representation of a bicycle consistent that can be used with embodiments of the present invention.

FIG. 2A is a seat assembly arrangement constructed in accordance with an embodiment of the present invention.

FIG. 2B is a top view of a bicycle constructed in accordance with an embodiment of the present invention.

FIG. 3A and is a perspective drawing of a bottle holder used to illustrate an embodiment of the present invention.

FIG. 3B is a side view drawing of a bottle holder attached to a seat assembly consistent with embodiments of the present invention.

FIG. 4 is an alternative embodiment of a side view drawing of a bottle holder attached to a seat assembly consistent with embodiments of the present invention.

FIG. 5 is an alternative embodiment of a side view drawing of a bottle holder attached to a seat assembly consistent with embodiments of the present invention.

FIG. 6 is an alternative embodiment of a side view drawing of a bottle holder attached to a seat assembly consistent with embodiments of the present invention.

FIG. 7 is an alternative embodiment of a side view drawing of a bottle holder attached to a seat assembly consistent with embodiments of the present invention.

### DETAILED DESCRIPTION

The present invention relates generally to a bottle holding apparatus 200 disposed on or in proximity to a bicycle seat 110.

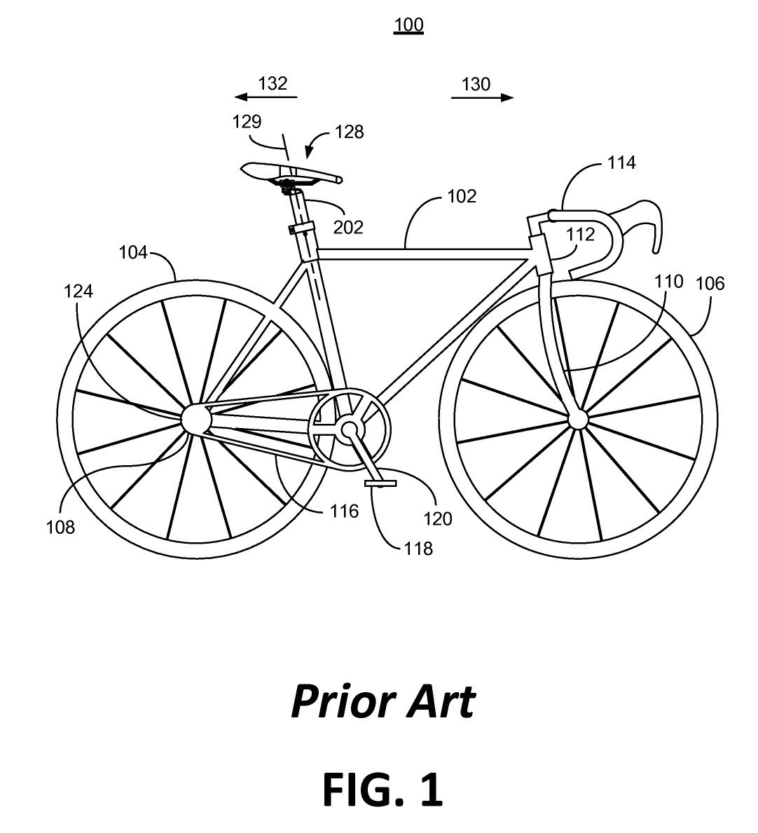

Embodiments of the present invention can be commercially practiced with a touring or racing bicycle, such as a Cervelo R3, for example, as shown in FIG. 1. The Cervelo R3 represents a typical bicycle 100 possessing a frame 102 that is supported by a rear wheel 104 and a front wheel 106. As illustratively shown, the rear wheel 104 is attached the frame via a hub assembly 108 and the front wheel 106 is attached to a front fork device 110 which pivots axially about a portion of the frame 102 known to those skilled in the art as a head tube 112. The front fork device 110 is integrated with handle bar 114 which serves as a means for steering the bicycle 100. The bicycle 100 is manually driven by a chain drive system 116 that links a peddle 118, crank 120 and front sprocket 122 which are attached to the frame 102 via a bottom bracket (not shown) to a rear gear system 124 known to those skilled in the art as a rear cluster 124. The cluster 124 is connected to the hub assembly 108 of the rear wheel 104 thus forcing the rear wheel 104 to rotate about its axis when the crank 120 is manually rotated. Hence, when a bicycle rider (not shown) applies a rotational force to the peddles 118 and crank 120, the rotational force is translated to the rear wheel 104 via the rear cluster 124 and chain 116 thus causing the bicycle 100 to move, generally, in a forward direction, in-line with the wheels 104 and 106. The bicycle rider (not shown) sits on a seat assembly 128 approximately over the rear wheel 104 as shown, steering the bicycle 100 via the handlebars 114. The front 130 of the bicycle 100 is approximately where the handle bars 114 and the front wheel 106 are disposed. The rear 132 of the bicycle 100 is approximately where the rear wheel 104 and the seat assembly 128 are disposed. The seat assembly 128 possesses a seat assembly axis 129 that essentially runs along axially along the center of the seat post 202.

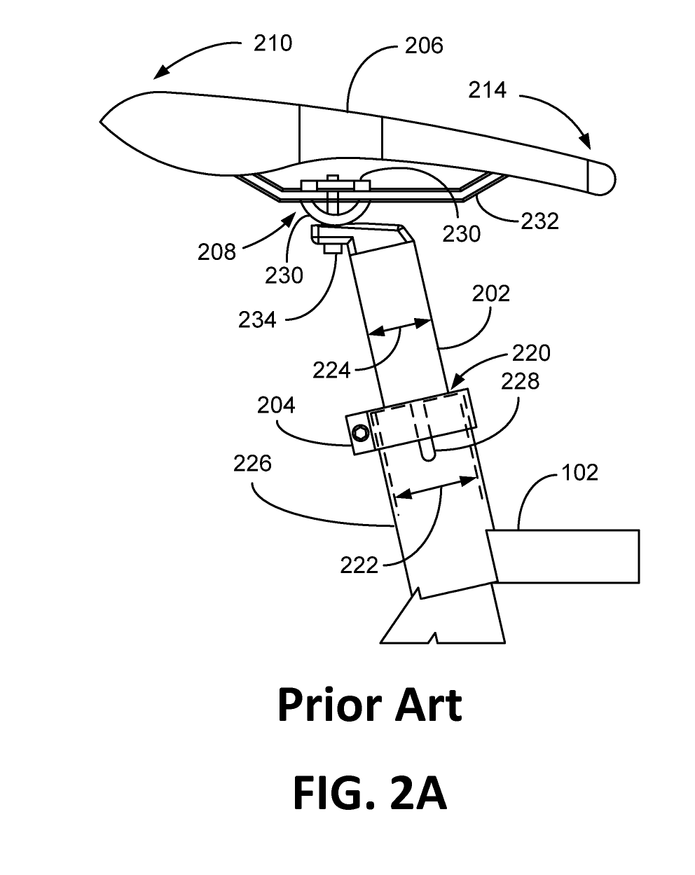

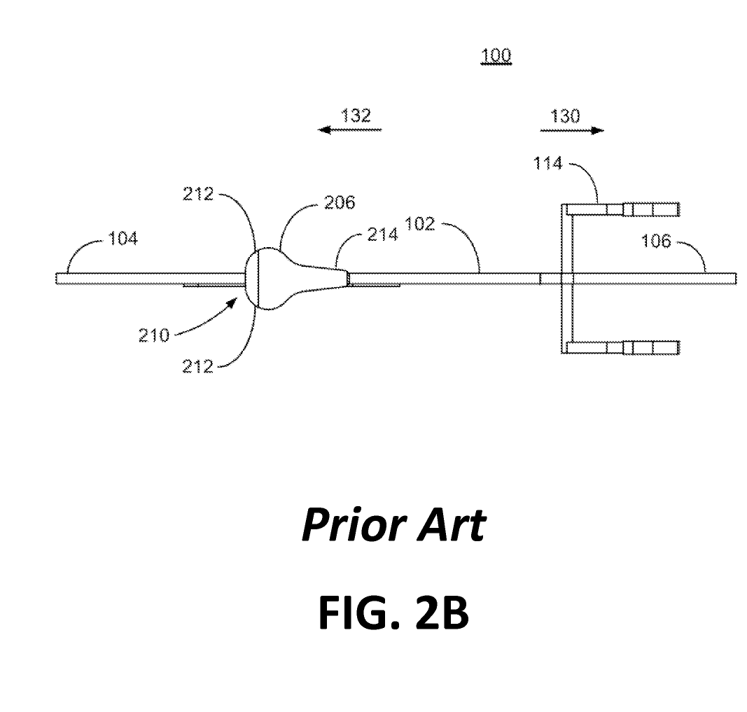

FIG. 2A shows one embodiment of a seat assembly 128 which is illustratively shown including a seat post 202, a seat post to frame clamping device 204 that substantially fixedly retains the seat post 202 in the frame 102, a seat 206, and a seat to seat post retaining assembly 208 that substantially fixedly retains the seat 206 to the seat post 202. Though the seat 206 can vary in construction and shape, generally, a seat 206 is triangular in shape as viewed from the top of the bicycle 100 as shown in FIG. 2B. The rear 210 of the seat 206 includes the two of the corners 212 of the seat 206 that extend towards the rear 132 of the bicycle 100. The front 214 of the seat 206 includes the remaining corner 216 of the seat 206 that extends towards the front 130 of the bicycle 100. The rear 210 of the bicycle seat 206 is constructed to support most of the weight of the bicycle rider (not shown) via the rider's derriere (not shown).

With continued reference to the seat post 202 and seat post to frame clamping device 204, the seat post 202 is essentially a tubular member that slidingly engages an accommodating opening 220 in the frame 102 such that the inner diameter 222 of the frame's opening is slightly larger than the outer diameter 224 of the seat post 202. Hence, as illustratively shown, the seat post 202 is adapted to slide inside of the accommodating tubular member 226 of the frame 102 along the seat assembly axis 129. The frame 102 possesses a slot 228 (partially revealed) that allows the frame 102 to squeeze the seat post 202 when the seat post to frame clamping device 204 is engaged to immobilize the seat post 202 in a fixed position.

With continued reference to FIG. 2A, as illustratively shows the seat 206 is fixedly attached to the sea post 202 via a seat post retaining fixture 230 cooperates with a pair of support rails 232 (only one is shown in this illustration with a like rail 232 behind the one revealed) on the underside of the seat 206. The retaining fixture 230 is generally comprised of a clamping device that conforms to the support rails 232 and immobilizes the seat 206 in a fixed position when engaged and tightened, such as by a bolt 234, as shown here.

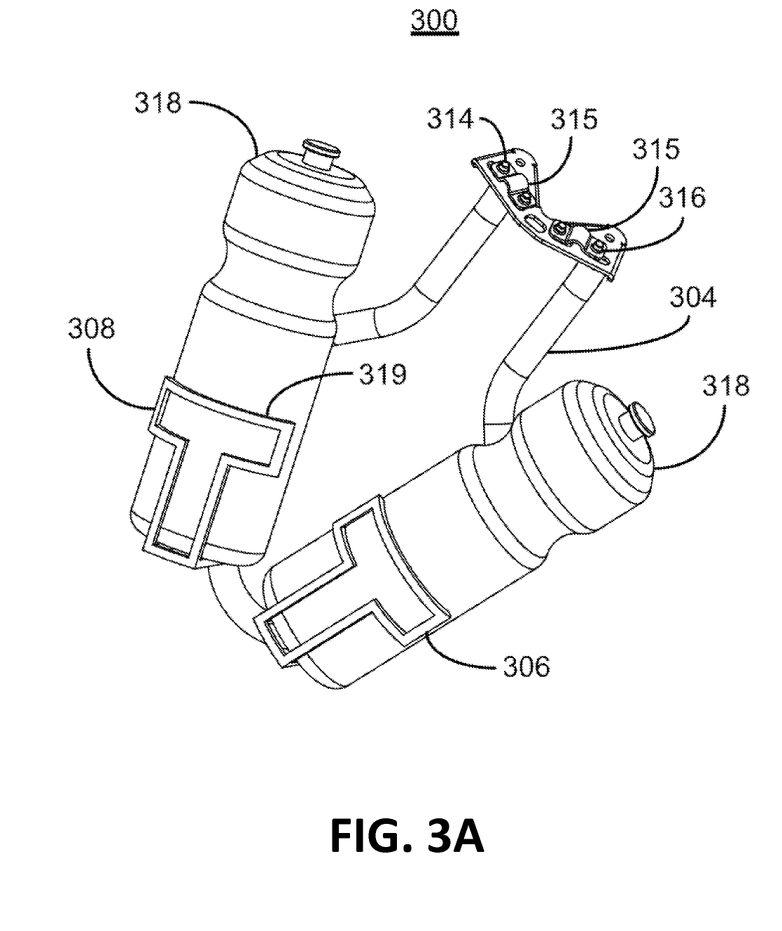

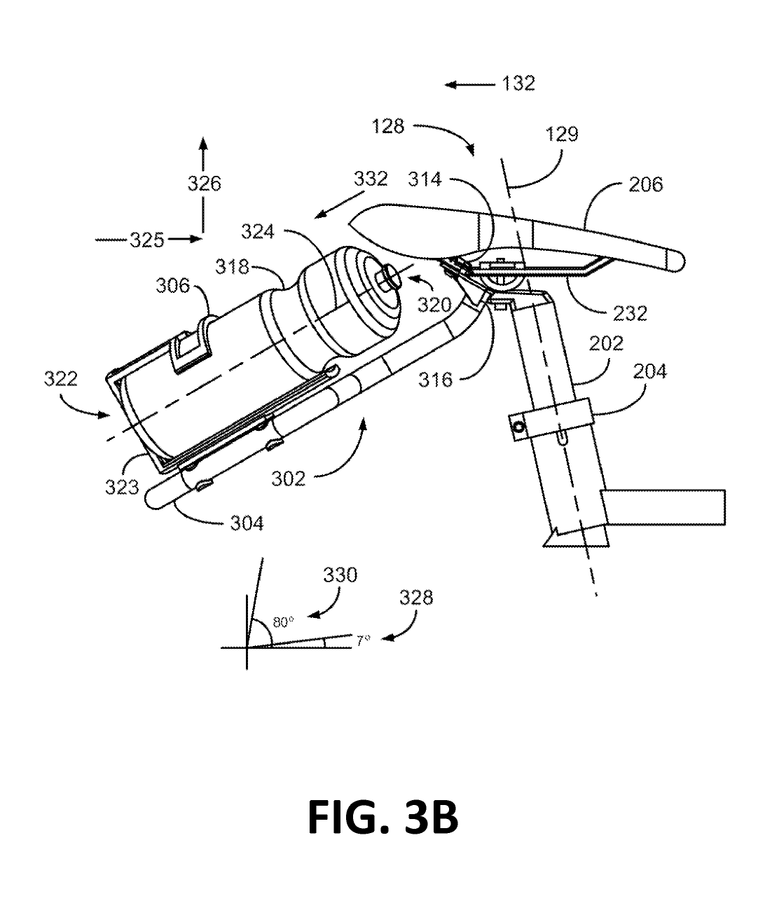

FIG. 3A is a perspective view of one embodiment of a bottle holder arrangement 300 consistent with the present invention. In this embodiment the bottle holder 302 is fixedly attached to the seat 206 via the support rails 232. As illustratively shown, the bottle holder 302 possesses a frame 304 that supports a first cage 306 and a second cage 308. The cages 306 and 308 can be a standard size, which accommodates standard sized bicycle bottles 318, such as plastic water bottles with a diameter of approximately 3 inches and length of approximately 10 inches. The cages 306 and 308, in one embodiment, can be standard carbon cages, such as Profile Design brand. Optionally, the cages 306 and 308 can be standard aluminum cages. As one skilled in the art will recognize, the cages can be custom or off the shelf product that can range in materials from carbon to a polymer to aluminum, just to provide several examples. The frame 304, in the present embodiment is tubular metal and provides holes (not shown) that accommodate attachment holes (not shown) located in the cages 306 and 308. The cages 306 and 308 are fixedly attached to the frame 304, such as by a pair of metal couplings 315 that conforms to the rails 232 by bolts 314 and lock washers 316, as shown. The cages 306 and 308, can optionally be fixedly attached to the frame by other means such as glue, rivets, straps, or other means for attaching that are known in the art. The cages 306 and 308 have a receiving end 319 that first encounter the bottles 318 during the process of disposing the bottles 318 in the cages 306 and 308.

With reference to FIG. 3B, shown therein is a side view of the bottle holder 302 of FIG. 3A populated with bottles 318. The bottle holder 302 is fixedly attached to the seat 206 via the support rails 232 such that the bottle holder 302 extends from behind the seat assembly 128 towards the back of the bicycle 132. As illustratively shown, only one cage 306 is shown because the cages are coplanar, thus the other cage 308 is hidden from view. The cages 306 and 308 are adapted to retain a bottle 318 such that the top end 320 of the bottle 318 is above the bottom end 322 of the bottle 318. The top end 320 of the bottle 318 is also closer to the seat post axis 129 than the bottom end 322 of the bottle 318 such that a bottle axis 324 that extends substantially concentrically through the top end 320 and bottom end 322 is at an angle of at least seven degrees 328 relative to the vertical direction 326, as shown. In another embodiment, the bottle axis 324 is less than eighty degrees 330, hence, in this embodiment, the axis is between seven degrees 328 and eighty degrees 330 in the vertical direction. The bottle 318 slidingly engages the cages 306 and 308 from the bottom end 322 of the bottle first in the direction as illustrated by arrow 332. The cages 306 and 308, in this embodiment, retain the bottle 318 by substantially conforming to a large portion of the bottle 318, as shown. The bottles 318 are supported in position by base ends 323 of the cages 306 and 308 such that the bottles 318 are prevented from continuing to go in the direction 332 when fully engaged in the bottle holders 306 and 308.

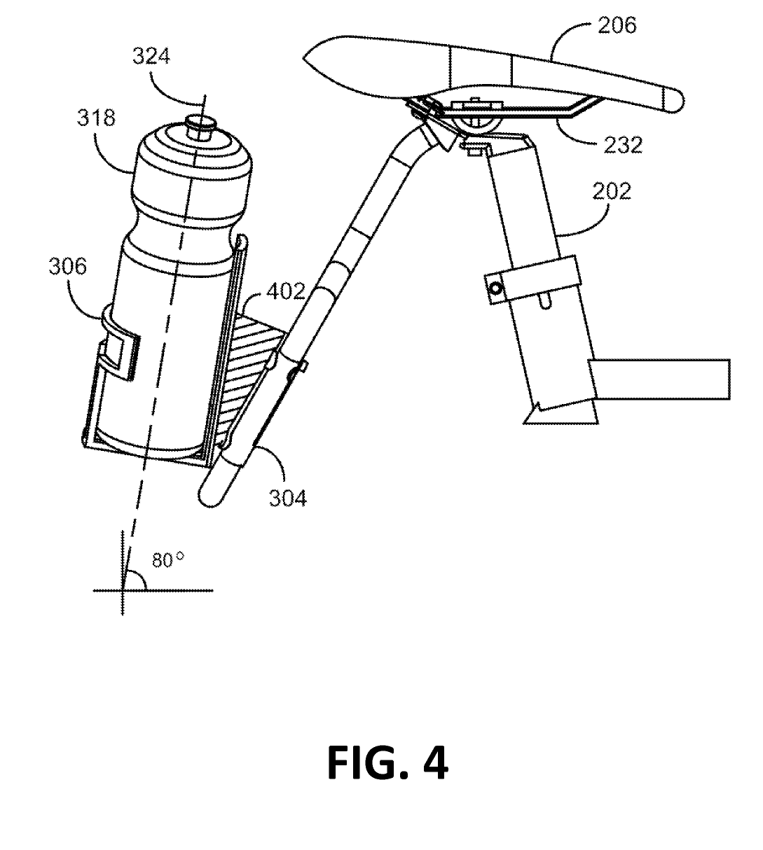

FIG. 4 shows an embodiment of the present invention wherein the bottle holder provides a means for retaining the bottle 318 at an angle between 7 degrees 328 and 80 degrees 330 in the vertical direction. As illustratively shown, a wedged structure 402 is integrated with a cages 404, thus creating the angle between 7 degrees 328 and 80 degrees 330 in the vertical direction.

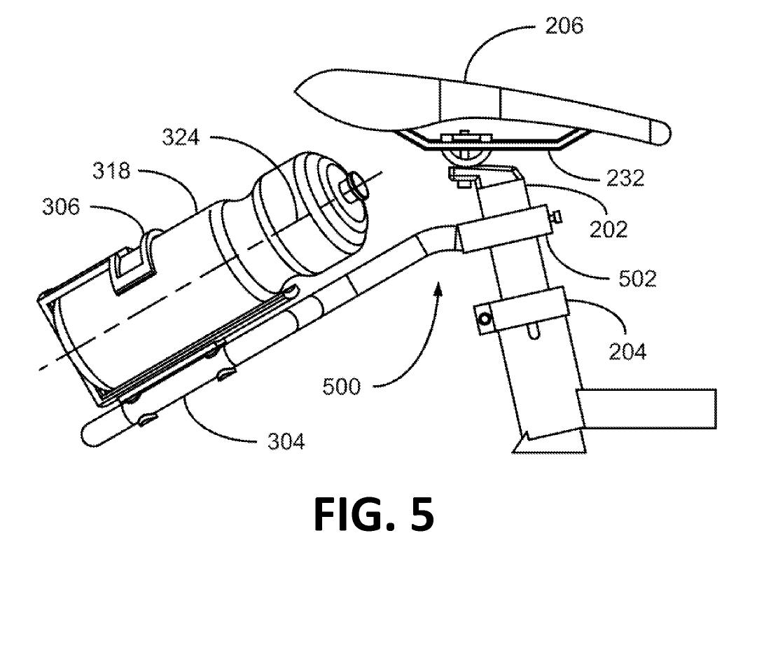

FIG. 5 shows an alternative embodiment of a bottle holder 500 fixedly attached to the seat post 202. In this embodiment, the bottle holder 500 possesses a seat post clamping fixture 502 that conforms to the seat post 202. When engaged, the seat post clamping fixture 502 is clamped around the seat post 202 to substantially immobilize the bottle holder 500. Optionally, the bottle holder 500 can be partially held in place by a support structure (not shown) attached to the seat 206 or the rails 232 associated with the seat 206. In another alternative embodiment the bottle holder 500 can be partially held in place by resting on the seat post to frame clamping device 204. It should be clear that there are numerous ways of fixedly attaching the bottle holder 500 to the seat assembly or in proximity thereof, without departing from the spirit and scope of the present invention.

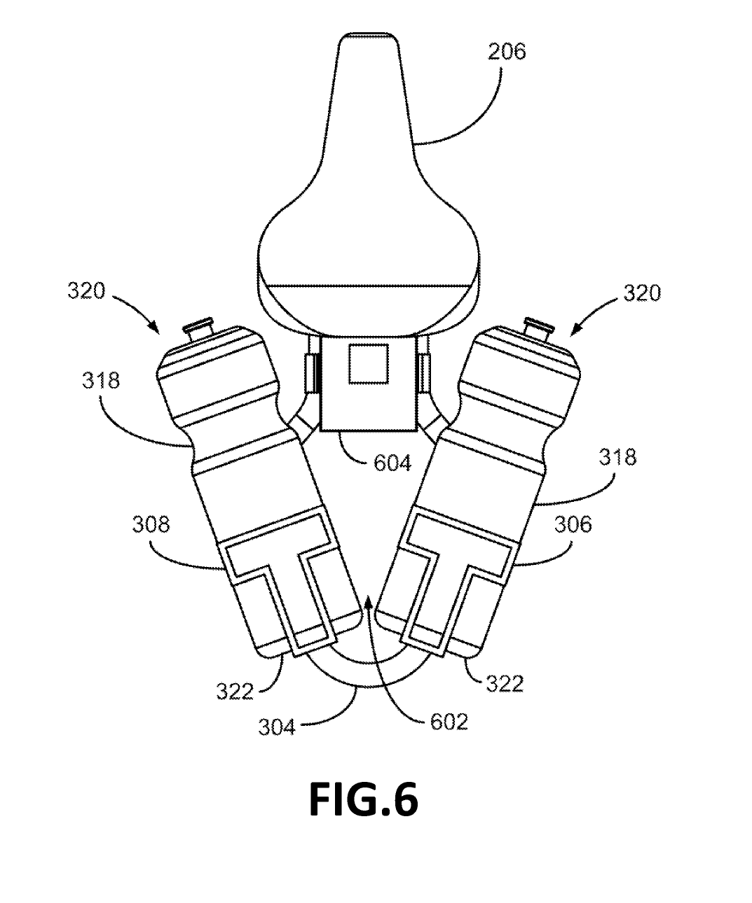

FIG. 6 shows and embodiment of the bottle holder 302 of FIG. 3A viewed in the horizontal plane. As illustratively shown the cages 306 and 308 are populated with bottles 318 such that the bottles 318 are positioned with the top ends 320 further apart than the bottom ends 322. The bottle holder 302 further provides a utility space 602 between the bottles 318 that can accommodate a utility bag 604, for example. The cages 306 and 308, in an optional embodiment, can be adapted to adjust their respective spacing by providing slots, for example, at the attachment points in the frame 304 of the bottle holder 302. Adjustment of the utility space 602 can accommodate different sized utility bags 604, or other things that may be desirable to carry with the bottle holder arrangement 300.

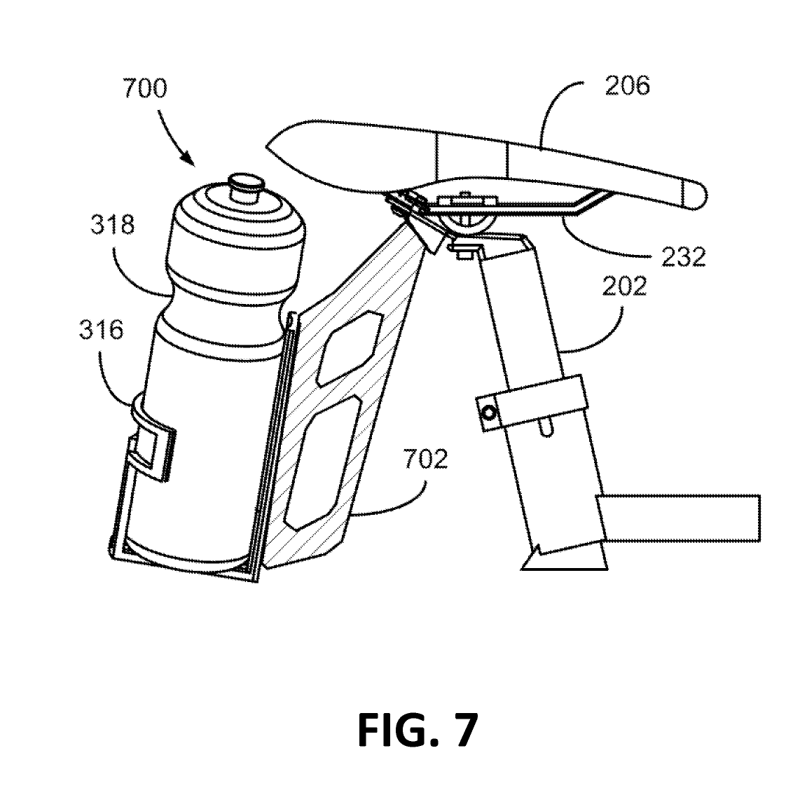

FIG. 7 shows an alternative embodiment wherein the bottle holder frame 702 is constructed from a composite carbon to take advantage of high stiffness to light weight. In the present configuration, the bottle holder 700, is functionally similar to that shown in FIG. 3A but may provide some weight, performance, and manufacturing benefits known to those skilled in the art.

A method for using a dual bottle holder assembly 300 consistent with embodiments of the present invention can, therefore, comprise: providing a seat assembly 128 that cooperates with a bicycle 100, the seat assembly 128 having a seat post 202 extending at least partially in a vertical direction 326 from the bicycle 100. The dual bottle holder assembly 300 can further comprise a frame 304 attached to the seat assembly 128, a first cage 306 and a second cage 308 attached to the frame 304 wherein the first cage 306 possesses an associated receiving end 319 and the second cage 308 possesses an associated receiving end 319. A bottle 318 can be inserted in the receiving end 319 of the first cage 306, the bottle 318 having a top end 320 and a bottom end 322. The bottle 318 can then be retained in the first bottle cage 306 in a position wherein the top end 320 is above the bottom end 322 and the top end 320 is closer to the seat assembly axis 129 than the bottom end 322 and wherein a bottle axis 324 associated with the bottle 318 extends substantially centrically through the top end 320 and bottom end 322 is at an angle of least seven degrees 328 from the horizontal 325 in the vertical direction 326.

Therefore, aspects of the present invention can include: a bottle holder for a bicycle comprising: a frame attachable to a seat post assembly, the seat post assembly having a seat post extending at least partially in a vertical direction from the bicycle along a seat post axis, the seat post axis extending concentrically along the length of the seat post; a first cage and a second cage attached to the frame wherein each of the cages are adapted to retain a bottle, the bottle possessing a top end and a bottom end wherein, when retained in either of the cages, the top end of the bottle is above the bottom end of the bottle and the top end of the bottle is closer to the seat post axis than the bottom end of the bottle such that a bottle axis that extends substantially centrically through the top and bottom ends is at an angle of least seven degrees relative to the vertical direction. The frame can solely attached to the seat post assembly. The angle can be less than eighty degrees. Either of the cages can receive the bottle via a receiving end associated with the cages wherein the bottle slidably engages the cages from the bottom end of the bottle first. The seat assembly can further comprise a bicycle seat and wherein the frame is at least partially attached therewith. The frame can extend away from the back of the bicycle seat. Each of the cages provides a means for retaining the bottle at the angle. The bottle holder can further comprise a utility space between the first cage and the second cage. The utility space can be capable of accommodating a utility bag. The first cage and the second cage can be adapted to be moved apart to alter the utility space. The first cage can possess a first receiving end and a first base end and the second cage possesses a second receiving end and a second base end, the receiving ends are further apart than the base ends. The first cage and the second cage can be arranged coplanar. The angle can be adjustable.

In another aspect of the present invention, method for using a dual bottle holder can comprise steps for: providing a seat post assembly that cooperates with a bicycle, the seat post assembly having a seat post extending at least partially in a vertical direction from the bicycle and having a seat post axis extends concentrically along the length of the seat post; providing a frame attached to the seat post assembly, a first cage and a second cage attached to the frame wherein the first cage possesses a first receiving end and the second cage possesses a second receiving end; inserting a first bottle in the first receiving end, the bottle having a top end and a bottom end; and retaining the first bottle in the first bottle cage in a position wherein the top end is above the bottom end and the top end is closer to the seat post axis than the bottom end and wherein a bottle axis associated with the first bottle that extends substantially centrically through the top and bottom ends is at an angle of least seven degrees relative to the vertical direction. The method can further comprise the steps for: inserting a second bottle, that is similar in construction to the first bottle, in the second receiving end; and retaining the second bottle in the second bottle cage at the angle. The method can further comprise the step for attaching a utility bag in an accommodating space between the first bottle cage and the second bottle cage.

In yet another aspect of the present invention, a bottle holder for a bicycle can comprise a means for attaching a frame to a seat post assembly, the seat post assembly having a seat post extending at least partially in a vertical direction from the bicycle wherein the seat post possesses a seat post axis that extends concentrically along the length of the seat post; a first cage and a second cage attached to the frame wherein each of the cages provides a means for retaining a bottle at an angle of at least seven degrees wherein the at least seven degrees is established by a bottle axis that extends substantially centrically through a top end of the bottle and bottom end of the bottle relative to the vertical direction, the top end of the bottle is above the bottom end of the bottle and the top end of the bottle is closer to the seat post axis than the bottom end of the bottle. The bottle holder can further comprise a means for attaching a utility bag to the bottle holder in an accommodating utility space. The bottle holder can further comprise a means for adjusting the utility space. The angle can be constrained.

It is to be understood that even though numerous characteristics and advantages of various embodiments of the present invention have been set forth in the foregoing description, together with the details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, a bottle holder though shown as a cage can be constructed in a number of ways to support a bottle while still maintaining substantially the same functionality without departing from the scope and spirit of the present invention. Another example can include stability bars for the bottle holder and retaining features to stabilize a bottle not explicitly while still maintaining substantially the same functionality without departing from the scope and spirit of the present invention. Finally, although the preferred embodiments described herein are directed to liquid bottle holders, and related technology, it will be appreciated by those skilled in the art that the teachings of the present invention can be applied to other objects that a rider may find desirable to dispose in the disclosed holder, without departing from the spirit and scope of the present invention.

It will be clear that the present invention is well adapted to attain the ends and advantages mentioned as well as those inherent therein. While presently preferred embodiments have been described for purposes of this disclosure, numerous changes may be made which readily suggest themselves to those skilled in the art and which are encompassed in the spirit of the invention disclosed and as defined in the appended claims.

What is claimed is:

1. A bottle holder for a bicycle comprising:
a frame attachable to a seat post assembly, said seat post assembly having a seat post extending at least partially in a vertical direction from said bicycle along a seat post axis, said seat post axis extending concentrically along the length of said seat post;
a first cage and a second cage attached to said frame wherein each of said cages are adapted to retain a bottle, said bottle possessing a top end and a bottom end wherein, when retained in either of said cages, said top end of said bottle is above said bottom end of said bottle and said top end of said bottle is closer to said seat post axis than said bottom end of said bottle such that a bottle axis that extends substantially centrically through said top and bottom ends is at an angle of least seven degrees relative to said vertical direction.

2. The bottle holder of claim 1 wherein said frame is solely attached to said seat post assembly.

3. The bottle holder of claim 1 wherein said angle is less than eighty degrees.

4. The bottle holder of claim 1 wherein either of said cages receives said bottle via a receiving end associated with said cages wherein said bottle slidably engages said cages from said bottom end of said bottle first.

5. The bottle holder of claim 1 wherein said seat post assembly further comprises a bicycle seat and wherein said frame is at least partially attached therewith.

6. The bottle holder of claim 5 wherein said frame extends away from the back of said bicycle seat.

7. The bottle holder of claim 1 wherein each of said cages provides a means for retaining said bottle at said angle.

8. The bottle holder of claim 1 further comprising a utility space between said first cage and said second cage.

9. The bottle holder of claim 8 wherein said utility space is capable of accommodating a utility bag.

10. The bottle holder of claim 8 wherein said first cage and said second cage are adapted to be moved apart to alter said utility space.

11. The bottle holder of claim 1 wherein said first cage possesses a first receiving end and a first base end and said second cage possesses a second receiving end and a second base end, said receiving ends are further apart than said base ends.

12. The bottle holder of claim 6 wherein said first cage and said second cage are coplanar.

13. The bottle holder of claim 1 wherein said angle is adjustable.

14. A method for using a dual bottle holder comprising steps for:
providing a seat post assembly that cooperates with a bicycle, said seat post assembly having a seat post extending at least partially in a vertical direction from said bicycle and having a seat post axis extending concentrically along the length of said seat post;
providing a frame attached to said seat post assembly, a first cage and a second cage attached to said frame wherein said first cage possesses a first receiving end and said second cage possesses a second receiving end;
a) inserting a first bottle in said first receiving end, said bottle having a top end and a bottom end; and
b) retaining said first bottle in said first bottle cage in a position wherein said top end is above said bottom end and said top end is closer to said seat post axis than said bottom end and wherein a bottle axis associated with said first bottle that extends substantially centrically through said top and bottom ends is at an angle of least seven degrees relative to said vertical direction.

15. The method of claim 14 further comprising the steps for:
a) inserting a second bottle, that is similar in construction to said first bottle, in said second receiving end; and
b) retaining said second bottle in said second bottle cage at said angle.

16. The method of claim 14 further comprising the step for attaching a utility bag in an accommodating space between said first bottle cage and said second bottle cage.

17. A bottle holder for a bicycle comprising:
a means for attaching a frame to a seat post assembly, said seat post assembly having a seat post extending at least partially in a vertical direction from said bicycle wherein said seat post possesses a seat post axis that extends concentrically along the length of said seat post;
a first cage and a second cage attached to said frame wherein each of said cages provides a means for retaining a bottle at an angle of at least seven degrees wherein said at least seven degrees is established by a bottle axis that extends substantially centrically through a top end of said bottle and bottom end of said bottle relative to said vertical direction, said top end of said bottle is above said bottom end of said bottle and said top end of said bottle is closer to said seat post axis than said bottom end of said bottle.

18. The bottle holder of claim 17 further comprising a means for attaching a utility bag to said bottle holder in an accommodating utility space.

19. The bottle holder of claim 18 further comprising a means for adjusting said utility space.

20. The bottle holder of claim 17 wherein said angle is not adjustable.
